(19) United States
(12) Patent Application Publication
(10) Pub. No.: US 2024/0079631 A1
(43) Pub. Date: Mar. 7, 2024

(54) BATTERY CELL AND METHOD OF MANUFACTURING SAME

(71) Applicant: PRIME PLANET ENERGY & SOLUTIONS, INC., Tokyo (JP)

(72) Inventors: Kaito KARASUNO, Kakogawa-shi (JP); Hiroshi TAKABAYASHI, Koriyama-shi (JP)

(73) Assignee: PRIME PLANET ENERGY & SOLUTIONS, INC., Tokyo (JP)

(21) Appl. No.: 18/456,690

(22) Filed: Aug. 28, 2023

(30) Foreign Application Priority Data
Aug. 30, 2022 (JP) 2022-136592

(51) Int. Cl. H01M 10/04; H01M 50/176; H01M 50/417; H01M 50/533; H01M 50/557

(52) U.S. Cl. CPC H01M 10/0413; H01M 50/176; H01M 50/417; H01M 50/533; H01M 50/557

(57) ABSTRACT

A battery cell includes: a resin insulator having a first portion, a second portion, and a third portion, the first portion being a portion that insulates a terminal portion and a sealing plate from each other outside an exterior container, the second portion being a portion that insulates a current collector and the sealing plate from each other inside the exterior container, the third portion being a portion that has a tubular shape and that communicates with an electrolyte solution injection hole, wherein the third portion of the resin insulator includes a shielding portion that shields between at least a portion of the electrolyte solution injection hole and an electrode assembly, and the first portion, the second portion and the third portion of the resin insulator are molded to be integrated together.

### CROSS REFERENCE TO RELATED APPLICATIONS

This nonprovisional application is based on Japanese Patent Application No. 2022-136592 filed on Aug. 30, 2022 with the Japan Patent Office, the entire contents of which are hereby incorporated by reference.

### BACKGROUND OF THE INVENTION

### Field of the Invention

The present technology relates to a battery cell and a method of manufacturing the battery cell.

### Description of the Background Art

Japanese Patent Laying-Open No. 2019-129129 discloses a battery provided with a tubular body communicating with a liquid injection hole for injecting an electrolyte solution into a housing of a battery cell. Here, by providing a shielding portion interposed between the liquid injection hole and an electrode assembly, a separator can be suppressed from being turned over by the injection of the electrolyte solution and an electrical short circuit resulting therefrom can be suppressed.

Japanese Patent Laying-Open No. 2021-86813 discloses that at least a portion of each of a case member and a current collecting terminal of a battery in contact with an insulating material is processed to have a rough surface, thus resulting in an improved anchor effect.

### SUMMARY OF THE INVENTION

By providing the insulating member provided with the tubular body, the number of components of the battery is increased. Further, it has been required to reduce the number of assembling steps at the time of manufacturing the battery.

It is an object of the present technology to provide a battery cell and a method of manufacturing the battery cell so as to suppress a separator from being turned over at the time of injection of an electrolyte solution and suppress a short circuit resulting therefrom, while reducing the number of assembling steps.

The present technology provides a battery cell and a method of manufacturing the battery cell as follows.

[1] A battery cell comprising: an electrode assembly including a positive electrode plate and a negative electrode plate; an exterior container that is provided with an opening and that accommodates the electrode assembly; a sealing plate that is provided with a terminal portion insertion hole and an electrolyte solution injection hole and that seals the opening of the exterior container; a terminal portion that extends through the terminal portion insertion hole; a current collector electrically connected to the positive electrode plate or the negative electrode plate; and a resin insulator having a first portion, a second portion, and a third portion, the first portion being a portion that insulates the terminal portion and the sealing plate from each other outside the exterior container, the second portion being a portion that insulates the current collector and the sealing plate from each other inside the exterior container, the third portion being a portion that has a tubular shape and that communicates with the electrolyte solution injection hole, wherein the third portion of the resin insulator includes a shielding portion that shields between at least a portion of the electrolyte solution injection hole and the electrode assembly, and the first portion, the second portion, and the third portion of the resin insulator are molded to be integrated together.

[2] The battery cell according to [1], wherein the terminal portion and the resin insulator are integrated together by insert molding.

[3] The battery cell according to [1] or [2], wherein at least a portion of a contact surface of the terminal portion or the sealing plate with the resin insulator has a rough surface.

[4] The battery cell according to any one of [1] to [3], wherein the shielding portion includes a strip-shaped portion formed to extend across the third portion having the tubular shape.

[5] The battery cell according to [4], wherein a through hole is formed in the strip-shaped portion of the shielding portion.

[6] The battery cell according to [4] or [5], wherein the strip-shaped portion includes a first strip-shaped portion extending in a first direction and a second strip-shaped portion extending in a direction intersecting the first direction.

[7] The battery cell according to any one of [1] to [3], wherein the shielding portion includes a portion formed to have a substantially polygonal shape.

[8] The battery cell according to any one of [1] to [3], wherein the shielding portion is formed only on one side with respect to a center of the third portion having the tubular shape.

[9] A method of manufacturing a battery cell, the method comprising: forming an electrode assembly including a positive electrode plate and a negative electrode plate; electrically connecting the positive electrode plate or the negative electrode plate and a current collector to each other; attaching a terminal portion and a resin insulator to a sealing plate provided with an electrolyte solution injection hole; connecting the current collector and the terminal portion to each other; accommodating the electrode assembly in an exterior container provided with an opening; sealing the opening of the exterior container with the sealing plate; and injecting an electrolyte solution into the exterior container via the electrolyte solution injection hole, wherein the resin insulator has a first portion, a second portion, and a third portion, the first portion being a portion that insulates the terminal portion and the sealing plate from each other outside the exterior container, the second portion being a portion that insulates the current collector and the sealing plate from each other inside the exterior container, the third portion being a portion that has a tubular shape and that communicates with the electrolyte solution injection hole, the third portion of the resin insulator includes a shielding portion that shields between at least a portion of the electrolyte solution injection hole and the electrode assembly, and the first portion, the second portion, and the third portion of the resin insulator are molded to be integrated together.

[10] The method of manufacturing the battery cell according to [9], wherein the terminal portion and the resin insulator are integrated together by insert molding.

[11] The method of manufacturing the battery cell according to [9] or [10], further comprising providing a rough surface in at least a portion of a contact surface of the terminal portion or the sealing plate with the resin insulator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a battery cell.

FIG. 2 is a plan view of a positive electrode plate included in an electrode assembly.

FIG. 3 is a plan view of a negative electrode plate included in the electrode assembly.

FIG. 4 is a plan view showing the electrode assembly including the positive electrode plate and the negative electrode plate.

FIG. 5 is a diagram showing a structure of connection between the electrode assembly and each of a positive electrode current collecting member and a negative electrode current collecting member.

FIG. 6 is a perspective view showing a state in which electrode terminals are attached to a sealing plate.

FIG. 7 is a cross sectional view showing a state in which a positive electrode terminal is attached to the sealing plate.

FIG. 8 is a first diagram showing an exemplary shape of a shielding portion located between a liquid injection hole and the electrode assembly.

FIG. 9 is a second diagram showing an exemplary shape of the shielding portion located between the liquid injection hole and the electrode assembly.

FIG. 10 is a third diagram showing an exemplary shape of the shielding portion located between the liquid injection hole and the electrode assembly.

FIG. 11 is a fourth diagram showing an exemplary shape of the shielding portion located between the liquid injection hole and the electrode assembly.

FIG. 12 is a fifth diagram showing an exemplary shape of the shielding portion located between the liquid injection hole and the electrode assembly.

FIG. 13 is a sixth diagram showing an exemplary shape of the shielding portion located between the liquid injection hole and the electrode assembly.

FIG. 14 is a seventh diagram showing an exemplary shape of the shielding portion located between the liquid injection hole and the electrode assembly.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

It should be noted that in the embodiments described below, when reference is made to number, amount, and the like, the scope of the present technology is not necessarily limited to the number, amount, and the like unless otherwise stated particularly. Further, in the embodiments described below, each component is not necessarily essential to the present technology unless otherwise stated particularly. Further, the present technology is not limited to one that necessarily exhibits all the functions and effects stated in the present embodiment.

It should be noted that in the present specification, the terms “comprise”, “include”, and “have” are open-end terms. That is, when a certain configuration is included, a configuration other than the foregoing configuration may or may not be included.

Also, in the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the “battery cell” can be mounted on vehicles such as a hybrid electric vehicle (HEV), a plug-in hybrid electric vehicle (PHEV), and a battery electric vehicle (BEV). It should be noted that the use of the “battery cell” is not limited to the use in a vehicle.

FIG. 1 is a perspective view showing a battery cell 100. As shown in FIG. 1, battery cell 100 has a prismatic shape. Battery cell 100 has an electrode terminal 110 (terminal portion), a housing 120 (exterior container), a gas-discharge valve 130, and a rivet 140.

Electrode terminals 110 are formed on housing 120. Electrode terminals 110 have a positive electrode terminal 111 and a negative electrode terminal 112 arranged side by side along an X axis direction (second direction) orthogonal to a Y axis direction (first direction). Positive electrode terminal 111 and negative electrode terminal 112 are provided to be separated from each other in the X axis direction.

Housing 120 has a rectangular parallelepiped shape and forms an external appearance of battery cell 100. Housing 120 includes: a case main body 120A that accommodates an electrode assembly (not shown) and an electrolyte solution (not shown); and a sealing plate 120B that seals an opening of case main body 120A. Sealing plate 120B is joined to case main body 120A by welding.

Housing 120 has an upper surface 121, a lower surface 122, a first side surface 123, a second side surface 124, and two third side surfaces 125.

Upper surface 121 is a flat surface orthogonal to a Z axis direction (third direction) orthogonal to the Y axis direction and the X axis direction. Electrode terminals 110 are disposed on upper surface 121. Lower surface 122 faces upper surface 121 along the Z axis direction.

Each of first side surface 123 and second side surface 124 is constituted of a flat surface orthogonal to the Y axis direction. Each of first side surface 123 and second side surface 124 has the largest area among the areas of the plurality of side surfaces of housing 120. Each of first side surface 123 and second side surface 124 has a quadrangular shape when viewed in the Y axis direction. Each of first side surface 123 and second side surface 124 has a quadrangular shape in which the X axis direction corresponds to the long-side direction and the Z axis direction corresponds to the short-side direction when viewed in the Y axis direction.

A plurality of battery cells 100 are stacked such that first side surfaces 123 of battery cells 100, 100 adjacent to each other in the Y axis direction face each other and second side surfaces 124 of battery cells 100, 100 adjacent to each other in the Y axis direction face each other. Thus, positive electrode terminals 111 and negative electrode terminals 112 are alternately arranged in the Y axis direction in which the plurality of battery cells 100 are stacked.

Gas-discharge valve 130 is provided in upper surface 121. When the temperature of battery cell 100 is increased (thermal runaway) and internal pressure of housing 120 becomes more than or equal to a predetermined value due to gas generated inside housing 120, gas-discharge valve 130 discharges the gas to outside of housing 120.

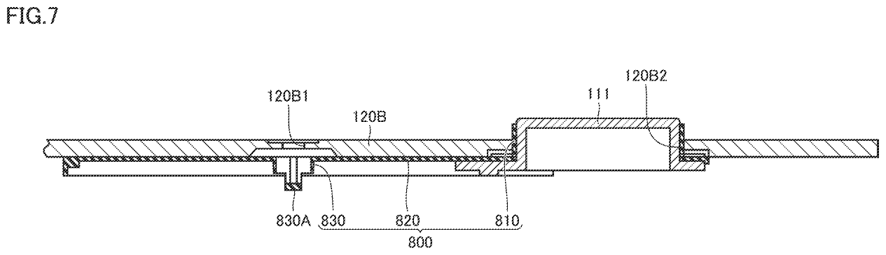

Rivet 140 is attached to sealing plate 120B of housing 120. Rivet 140 seals an electrolyte solution injection hole (see FIG. 7) described later.

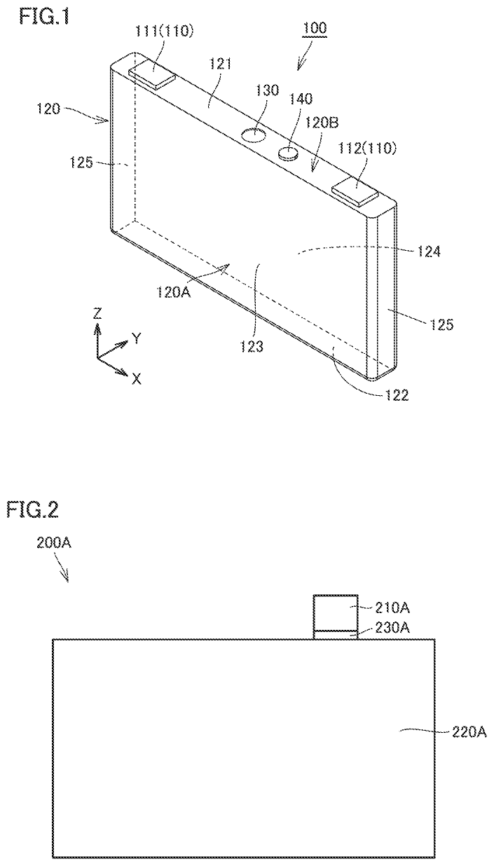

FIG. 2 is a plan view of a positive electrode plate 200A included in electrode assembly 200. Positive electrode plate 200A has a main body portion 220A in which a positive electrode active material composite layer is formed on each of both surfaces of a positive electrode core body constituted of an aluminum foil having a quadrangular shape, the positive electrode active material composite layer including a positive electrode active material (for example, lithium-nickel-cobalt-manganese composite oxide or the like), a binder (polyvinylidene difluoride (PVdF) or the like), and a conductive material (for example, a carbon material or the like). The positive electrode core body protrudes from an end side of the main body portion, and the positive electrode core body thus protruding constitutes positive electrode tab 210A. A positive electrode protection layer 230A including alumina particles, a binder, and a conductive material is provided on positive electrode tab 210A at a portion adjacent to main body portion 220A. Positive electrode protection layer 230A has an electric resistance larger than that of the positive electrode active material composite layer. The positive electrode active material composite layer may include no conductive material. Positive electrode protection layer 230A may not be necessarily provided.

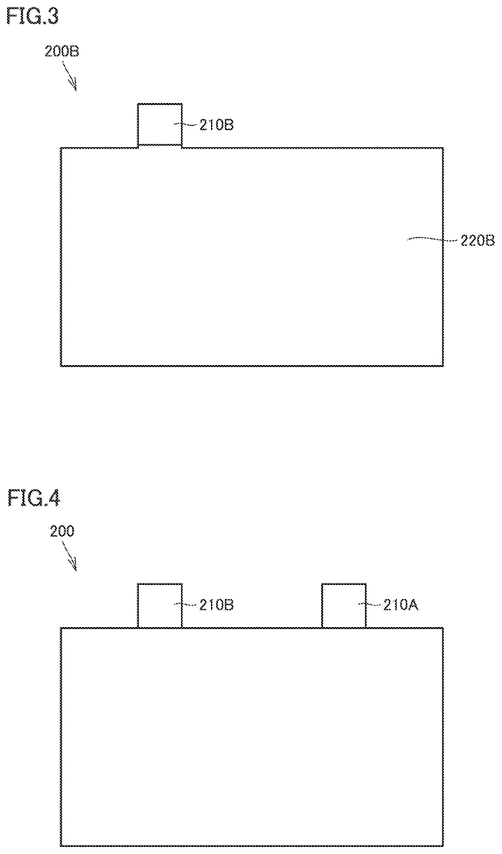

FIG. 3 is a plan view of a negative electrode plate 200B included in electrode assembly 200. Negative electrode plate 200B has a main body portion 220B in which a negative electrode active material composite layer is formed on each of both surfaces of a negative electrode core body constituted of a copper foil having a quadrangular shape. The negative electrode core body protrudes from an end side of main body portion 220B, and the negative electrode core body thus protruding constitutes negative electrode tab 210B.

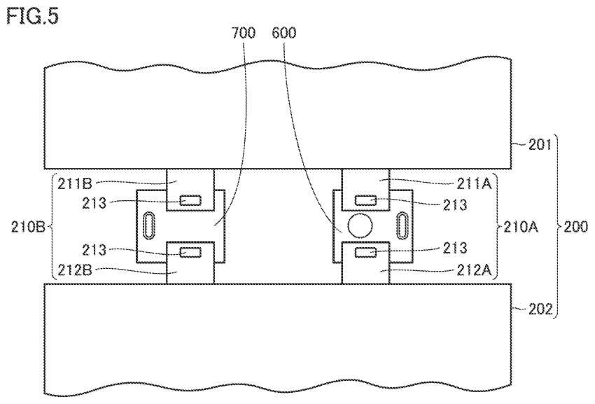

FIG. 4 is a plan view showing electrode assembly 200 including positive electrode plates 200A and negative electrode plates 200B. As shown in FIG. 5, electrode assembly 200 is produced such that positive electrode tabs 210A of positive electrode plates 200A are stacked and negative electrode tabs 210B of negative electrode plates 200B are stacked at one end portion of electrode assembly 200. For example, about 50 positive electrode plates 200A and about 50 negative electrode plates 200B are stacked. Positive electrode plates 200A and negative electrode plates 200B are alternately stacked with separators being interposed therebetween, each of the separators being composed of polyolefin, each of the separators having a quadrangular shape. It should be noted that a long separator may be used with the separator being folded in a meandering manner.

FIG. 5 is a diagram showing a structure of connection between electrode assembly 200 and each of a positive electrode current collecting member 600 and a negative electrode current collecting member 700. As shown in FIG. 5, electrode assembly 200 includes a first electrode assembly element 201 (first stack group) and a second electrode assembly element 202 (second stack group). Separators are also disposed on the respective outer surfaces of first electrode assembly element 201 and second electrode assembly element 202.

The plurality of positive electrode tabs 210A of first electrode assembly element 201 constitute a first positive electrode tab group 211A. The plurality of negative electrode tabs 210B of first electrode assembly element 201 constitute a first negative electrode tab group 211B. The plurality of positive electrode tabs 210A of second electrode assembly element 202 constitute a second positive electrode tab group 212A. The plurality of negative electrode tabs 210B of second electrode assembly element 202 constitute a second negative electrode tab group 212B.

Positive electrode current collecting member 600 and negative electrode current collecting member 700 are disposed between first electrode assembly element 201 and second electrode assembly element 202. First positive electrode tab group 211A and second positive electrode tab group 212A are connected onto positive electrode current collecting member 600 by welding, thereby forming welded connection portions 213. First negative electrode tab group 211B and second negative electrode tab group 212B are connected onto negative electrode current collecting member 700 by welding, thereby forming welded connection portions 213. Welded connection portions 213 can be formed by, for example, ultrasonic welding, resistance welding, laser welding, or the like.

When manufacturing battery cell 100, electrode assembly 200 including positive electrode plate 200A and negative electrode plate 200B is formed, and positive electrode plate 200A and negative electrode plate 200B are electrically connected to positive electrode current collecting member 600 and negative electrode current collecting member 700 (current collector), respectively. Next, positive electrode terminal 111 and negative electrode terminal 112 (terminal portion) attached to sealing plate 120B are connected (for example, connected by swaging) to positive electrode current collecting member 600 and negative electrode current collecting member 700, respectively. In this state, electrode assembly 200 is accommodated in case main body 120A, and the opening of case main body 120A is sealed by sealing plate 120B.

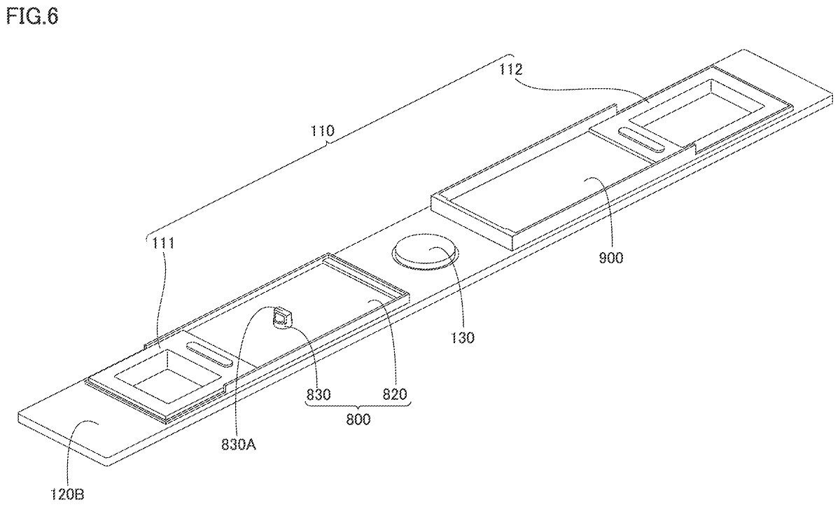

FIG. 6 is a perspective view showing a state in which electrode terminals 110 are attached to sealing plate 120B, and FIG. 7 is a cross sectional view showing the state (the positive electrode terminal 111 side) in FIG. 6.

As shown in FIGS. 6 and 7, sealing plate 120B is provided with an electrolyte solution injection hole 120B1 and a terminal portion insertion hole 120B2.

Each of electrode terminals 110 (FIG. 7 shows positive electrode terminal 111) is inserted in terminal portion insertion hole 120B2. After the opening of case main body 120A is sealed by sealing plate 120B, the electrolyte solution is injected into housing 120 through electrolyte solution injection hole 120B1.

Together with electrode terminals 110 (positive electrode terminal 111 and negative electrode terminal 112), resin insulators 800, 900 are attached to sealing plate 120B. Positive electrode terminal 111 and negative electrode terminal 112 may be respectively integrated with resin insulators 800, 900 by insert molding.

Resin insulator 800 has a first portion 810, a second portion 820, and a third portion 830, first portion 810 being a portion that insulates positive electrode terminal 111 and sealing plate 120B from each other outside housing 120, second portion 820 being a portion that insulates positive electrode current collecting member 600 and sealing plate 120B from each other inside housing 120, third portion 830 being a portion that has a tubular shape and that communicates with electrolyte solution injection hole 120B1.

Third portion 830 of resin insulator 800 includes a shielding portion 830A that shields between at least a portion of electrolyte solution injection hole 120B1 and electrode assembly 200. First portion 810, second portion 820, and third portion 830 are molded to be integrated together.

Since third portion 830 of resin insulator 800 includes shielding portion 830A that shields between at least the portion of electrolyte solution injection hole 120B1 and electrode terminal 110, the separator can be suppressed from being turned over at the time of injection of the electrolyte solution and an electrical short circuit resulting therefrom can be suppressed.

On the other hand, by providing the tubular body, i.e., the tubular portion (corresponding to third portion 830) that communicates with electrolyte solution injection hole 120B1, the number of components of battery cell 100 can be increased. Further, it has been required to reduce the number of steps of assembling components at the time of manufacturing battery cell 100.

In battery cell 100 according to the present embodiment, since resin insulator 800 is integrally molded to have first portion 810 that insulates positive electrode terminal 111 and sealing plate 120B from each other outside housing 120, second portion 820 that insulates positive electrode current collecting member 600 and sealing plate 120B from each other inside housing 120, and third portion 830 that has a tubular shape and that communicates with electrolyte solution injection hole 120B1, the number of components of battery cell 100 and the number of steps of assembling components can be reduced. As a result, battery cell 100 can be manufactured at low cost while suppressing the separator from being turned over at the time of injection of the electrolyte solution.

At least a portion of a contact surface of each of electrode terminal 110 and sealing plate 120B with each of resin insulators 800, 900 may has a rough surface. Since the rough surface is provided, adhesion between each of electrode terminal 110 and sealing plate 120B and each of resin insulators 800, 900 can be improved by an anchor effect.

The structures of electrode terminal 110, sealing plate 120B, and resin insulator 800 are not limited to those shown in FIGS. 6 and 7, and for example, electrode terminal 110 may have a current interrupt device (CID).

In the example of FIGS. 6 and 7, it has been illustratively described that resin insulator 800 on the positive electrode terminal 111 side and resin insulator 900 on the negative electrode terminal 112 side are separately formed, and third portion 830 that has a tubular shape and that communicates with electrolyte solution injection hole 120B1 is provided in the resin insulator on the positive electrode terminal 111 side; however, the scope of the present technology is not limited thereto. For example, the tubular portion (corresponding to third portion 830) communicating with electrolyte solution injection hole 120B1 may be provided in resin insulator 900 on the negative electrode terminal 112 side, or resin insulators 800, 900 may be provided as one member.

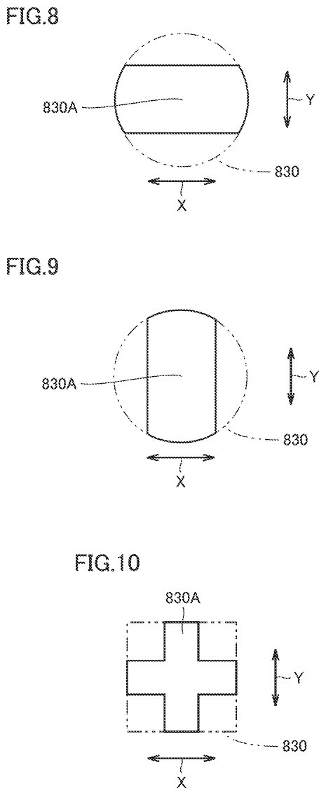

FIGS. 8 to 14 show exemplary shapes of shielding portion 830A. It should be noted that the shape of shielding portion 830A shown in each of FIGS. 8 to 14 is one example, and the scope of the present technology is not limited thereto.

In the example shown in each of FIGS. 8 and 9, shielding portion 830A is constituted of a strip-shaped portion formed to extend across third portion 830 having the tubular shape. In the example of FIG. 8, the strip-shaped portion extends in the X axis direction, whereas in the example of FIG. 9, the strip-shaped portion extends in the Y axis direction.

The strip-shaped portion may extend in an oblique direction intersecting each of the X axis direction and the Y axis direction. The width of the strip-shaped portion can be appropriately changed. Further, the strip-shaped portion may be formed to be separated into a plurality of portions.

In the example of each of FIGS. 8 and 9, the strip-shaped portion is formed in a region including the center of third portion 830 having the tubular shape; however, the scope of the present technology is not limited thereto.

As in the example of FIG. 10, the strip-shaped portion may include a first strip-shaped portion extending in the Y axis direction and a second strip-shaped portion extending in the X axis direction. In the example of FIG. 10, the shape of cross is shown in which the first strip-shaped portion and the second strip-shaped portion are substantially orthogonal to each other; however, the first strip-shaped portion and the second strip-shaped portion may intersect each other obliquely.

As in the example of FIG. 11, a through hole 831 may be formed in the strip-shaped portion. The position, shape, and size of through hole 831 may be appropriately changed. A plurality of through holes 831 may be provided as shown in FIG. 11, or only one through hole 831 may be provided.

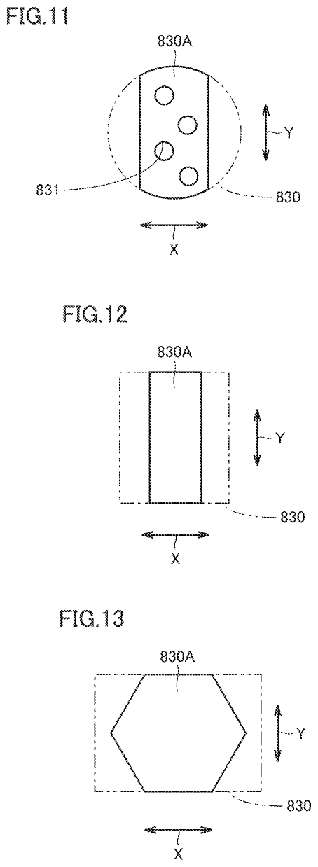

As in the example of FIG. 12, shielding portion 830A may be in the form of a rectangle (quadrangle). Further, the tubular shape of third portion 830 of resin insulator 800 is not limited to the circular shape, and may be a quadrangular shape as shown in FIG. 12.

As in the example of FIG. 13, shielding portion 830A may be formed to have a substantially polygonal shape including a shape other than a quadrangular shape. The substantially polygonal shape is not a complete polygon, and includes, for example, a shape with a corner portion processed to be rounded or processed to be chamfered. Further, the substantially polygonal shape is not limited to a regular polygonal shape as in the example of FIG. 13 (regular hexagonal shape).

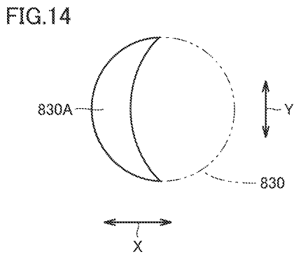

As in the example of FIG. 14, shielding portion 830A may be formed only on one side with respect to the center of third portion 830 having the tubular shape. In the example of FIG. 14, shielding portion 830A has a substantially crescent shape; however, the shape of shielding portion 830A can be appropriately changed also when shielding portion 830A is formed only on one side with respect to the center of third portion 830 having the tubular shape.

Although the embodiments of the present invention have been described and illustrated in detail, it is clearly understood that the same is by way of illustration and example only and is not to be taken by way of limitation, the scope of the present invention being interpreted by the terms of the appended claims. The scope of the present invention is defined by the terms of the claims, and is intended to include any modifications within the scope and meaning equivalent to the terms of the claims.

What is claimed is:

1. A battery cell comprising:
an electrode assembly including a positive electrode plate and a negative electrode plate;
an exterior container that is provided with an opening and that accommodates the electrode assembly;
a sealing plate that is provided with a terminal portion insertion hole and an electrolyte solution injection hole and that seals the opening of the exterior container;
a terminal portion that extends through the terminal portion insertion hole;
a current collector electrically connected to the positive electrode plate or the negative electrode plate; and
a resin insulator having a first portion, a second portion, and a third portion, the first portion being a portion that insulates the terminal portion and the sealing plate from each other outside the exterior container, the second portion being a portion that insulates the current collector and the sealing plate from each other inside the exterior container, the third portion being a portion that has a tubular shape and that communicates with the electrolyte solution injection hole, wherein
the third portion of the resin insulator includes a shielding portion that shields between at least a portion of the electrolyte solution injection hole and the electrode assembly, and
the first portion, the second portion, and the third portion of the resin insulator are molded to be integrated together.

2. The battery cell according to claim 1, wherein the terminal portion and the resin insulator are integrated together by insert molding.

3. The battery cell according to claim 1, wherein at least a portion of a contact surface of the terminal portion or the sealing plate with the resin insulator has a rough surface.

4. The battery cell according to claim 1, wherein
the terminal portion and the resin insulator are integrated together by insert molding, and
at least a portion of a contact surface of the terminal portion or the sealing plate with the resin insulator has a rough surface.

5. The battery cell according to claim 1, wherein the shielding portion includes a strip-shaped portion formed to extend across the third portion having the tubular shape.

6. The battery cell according to claim 5, wherein a through hole is formed in the strip-shaped portion of the shielding portion.

7. The battery cell according to claim 5, wherein the strip-shaped portion includes a first strip-shaped portion extending in a first direction and a second strip-shaped portion extending in a direction intersecting the first direction.

8. The battery cell according to claim 1, wherein
the terminal portion and the resin insulator are integrated together by insert molding, and
the shielding portion includes a strip-shaped portion formed to extend across the third portion having the tubular shape.

9. The battery cell according to claim 1, wherein
the terminal portion and the resin insulator are integrated together by insert molding,
at least a portion of a contact surface of the terminal portion or the sealing plate with the resin insulator has a rough surface, and
the shielding portion includes a strip-shaped portion formed to extend across the third portion having the tubular shape.

10. The battery cell according to claim 1, wherein the shielding portion includes a portion formed to have a substantially polygonal shape.

11. The battery cell according to claim 1, wherein
the terminal portion and the resin insulator are integrated together by insert molding, and
the shielding portion includes a portion formed to have a substantially polygonal shape.

12. The battery cell according to claim 1, wherein
the terminal portion and the resin insulator are integrated together by insert molding,
at least a portion of a contact surface of the terminal portion or the sealing plate with the resin insulator has a rough surface, and
the shielding portion includes a portion formed to have a substantially polygonal shape.

13. The battery cell according to claim 1, wherein the shielding portion is formed only on one side with respect to a center of the third portion having the tubular shape.

14. The battery cell according to claim 1, wherein
the terminal portion and the resin insulator are integrated together by insert molding, and
the shielding portion is formed only on one side with respect to a center of the third portion having the tubular shape.

15. The battery cell according to claim 1, wherein
the terminal portion and the resin insulator are integrated together by insert molding,
at least a portion of a contact surface of the terminal portion or the sealing plate with the resin insulator has a rough surface, and
the shielding portion is formed only on one side with respect to a center of the third portion having the tubular shape.

16. A method of manufacturing a battery cell, the method comprising:
forming an electrode assembly including a positive electrode plate and a negative electrode plate;
electrically connecting the positive electrode plate or the negative electrode plate and a current collector to each other;
attaching a terminal portion and a resin insulator to a sealing plate provided with an electrolyte solution injection hole;
connecting the current collector and the terminal portion to each other;
accommodating the electrode assembly in an exterior container provided with an opening;
sealing the opening of the exterior container with the sealing plate; and
injecting an electrolyte solution into the exterior container via the electrolyte solution injection hole, wherein
the resin insulator has a first portion, a second portion, and a third portion, the first portion being a portion that insulates the terminal portion and the sealing plate from each other outside the exterior container, the second portion being a portion that insulates the current collector and the sealing plate from each other inside the exterior container, the third portion being a portion that has a tubular shape and that communicates with the electrolyte solution injection hole,
the third portion of the resin insulator includes a shielding portion that shields between at least a portion of the electrolyte solution injection hole and the electrode assembly, and
the first portion, the second portion, and the third portion of the resin insulator are molded to be integrated together.

17. The method of manufacturing the battery cell according to claim 16, wherein the terminal portion and the resin insulator are integrated together by insert molding.

18. The method of manufacturing the battery cell according to claim 16, further comprising providing a rough surface in at least a portion of a contact surface of the terminal portion or the sealing plate with the resin insulator.

19. The method of manufacturing the battery cell according to claim 16, wherein the terminal portion and the resin insulator are integrated together by insert molding,
the method further comprising providing a rough surface in at least a portion of a contact surface of the terminal portion or the sealing plate with the resin insulator.
